(19) United States
(12) Patent Application Publication
(10) Pub. No.: US 2008/0216009 A1
(43) Pub. Date: Sep. 4, 2008

(54) Virtual Library File System

(76) Inventor: Paul Drallos, Berkley, MI (US)

Correspondence Address: HARNESS, DICKEY & PIERCE, P.L.C., P.O. BOX 828, BLOOMFIELD HILLS, MI, 48303, US

(21) Appl. No.: 12/040,955

(22) Filed: Mar. 3, 2008

Related U.S. Application Data
(60) Provisional application No. 60/904,680, filed on Mar. 2, 2007.

(51) Int. Cl. G06F 3/048

(52) U.S. Cl. 715/776

(57) ABSTRACT

A system and method of graphical display is provided. A publisher module receives link objects for display in a virtual library, generates virtual book objects, each virtual book object corresponding to a link object, and allows configuration of virtual characteristics associated with each virtual book object. The virtual characteristics include a size characteristic, a color characteristic, or a texture characteristic. Each link object is associated with at least one of an electronic file, an electronic directory, an electronic folder, a website, and a uniform resource locator (URL). A library module is in communication with the publisher module and displays the virtual book objects, within a predetermined format including a plurality of virtual shelves. A computer readable medium stores the virtual book objects, the configured virtual characteristics, and the link objects. The virtual book objects are maintained in the predetermined format, at configurable locations on the virtual shelves. Selecting a particular virtual book object opens an associated electronic file, an associated electronic directory, an associated electronic folder, an associated website, or an associated URL, corresponding to the link object.

### CROSS-REFERENCE TO RELATED APPLICATIONS

This application claims the benefit of U.S. Provisional Application No. 60/904,680, filed on Mar. 2, 2007. The disclosure of the above application is incorporated herein by reference.

### FIELD

The present disclosure relates to file systems and, more particularly, to graphical display for a file system.

### BACKGROUND

The statements in this section merely provide background information related to the present disclosure and may not constitute prior art.

Computer users have a variety of common complaints with respect to the ability to locate a particular file stored within a traditional computer file system. Because of the large hard disk capacities that are available for even modest computers and the proliferation of high-speed internet access, users tend to store a large amount and variety of information on their computers. For this reason, a particular file, such as a picture, document, data, etc., may be difficult for a user to find. The user may know that it is “somewhere” on the computer, but may not recall exactly where in the file system it is located.

Some computer users may organize the file system on their hard disk into an extensive hierarchical tree-structure, with directories, subdirectories, folders, and subfolders, which allow the user to store files in a particular way. However, when files are arranged in such a structure, the file may, and often does, lie at the bottom of several branching levels of subdirectories. As a result, the path to a file becomes something like navigating a series of paths which all look the same and which constantly fork into several other directions. Consequently, it is very easy to take a turn down the wrong branch and never get to the file you are looking for. Even if a user does not get lost, several interactions with the computer may be required to reach a desired file.

Furthermore, a project may require access to several files and program resources scattered all over a computer's hard disk or the Internet. Each time a new resource is needed, the user may have to laboriously navigate to those resources, expending additional time and risking the potential of getting lost.

### SUMMARY

A graphical display system is provided, including a publisher module, a library module, and a computer readable medium. The publisher module receives link objects for display in a virtual library, generates virtual book objects corresponding to the link objects, and allows configuration of virtual characteristics associated with the virtual book objects. The virtual characteristics includes at least one of a size characteristic, a color characteristic, and a texture characteristic. Each link object is associated with at least one of an electronic file, an electronic directory, an electronic folder, a website, and a uniform resource locator (URL). The library module is in communication with the publisher module and displays the virtual book objects, within a predetermined format including virtual shelves. The virtual book objects are maintained in the predetermined format, at configurable locations on the virtual shelves. The computer readable medium stores the virtual book objects, the configured virtual characteristics, and the link objects. Selecting a particular virtual book object opens the associated electronic file, associated electronic directory, associated electronic folder, associated website, or associated URL, corresponding to the link object.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a screen shot showing a perspective view of a virtual library file system;

FIG. 2 is a screen shot showing a perspective view of a virtual library file system;

FIG. 3 is a screen shot showing an overhead view of a virtual library file system;

FIG. 4 is a screen shot showing a bookcase of a virtual library file system;

FIG. 5 is a screen shot showing a bookshelf of a virtual library file system;

FIG. 6 is a screen shot showing bookshelves of a virtual library file system;

FIG. 7 is a screen shot showing an open book/file of a virtual library file system;

FIG. 8 is a screen shot showing a dialog box for setting book appearance properties;

FIG. 9 is a screen shot showing a dialog box for setting book appearance properties;

FIG. 10 is a screen shot showing a dialog box for setting book appearance properties;

FIG. 11 is a screen shot of a search window of a card catalog;

FIG. 12A is a flow chart for a library module of a virtual library system;

FIG. 12B is a flow chart for a library module of a virtual library system;

FIG. 12C is a flow chart for a library module of a virtual library system;

FIG. 12D is a flow chart for a library module of a virtual library system;

FIG. 13A is a flow chart for a publisher module of a virtual library system;

FIG. 13B is a flow chart for a publisher module of a virtual library system;

FIG. 14 is a flow chart for a control module of a virtual library system;

FIG. 15 is a flow chart for a search module of a virtual library system;

FIG. 16 is a flow chart for a native interface module of a virtual library system;

FIG. 17 is schematic view showing modules of a virtual library system.

### DETAILED DESCRIPTION

The following description is merely exemplary in nature and is not intended to limit the present disclosure, application, or uses. It should be understood that throughout the drawings, corresponding reference numerals indicate like or corresponding parts and features.

As used herein, the terms module, control module, computer, and controller may refer to an application specific integrated circuit (ASIC), one or more electronic circuits, a processor (shared, dedicated, or group) and memory that execute one or more software or firmware programs, a combinational logic circuit, and/or other suitable components that provide the described functionality. Further, as used herein, computer-readable medium may refer to any medium capable of storing data for a computer. Computer-readable medium may include, but is not limited to, CD-ROM, floppy disk, magnetic tape, other magnetic medium capable of storing data, memory, RAM, ROM, PROM, EPROM, EEPROM, flash memory, punch cards, dip switches, or any other medium capable of storing data for a computer. The various modules described herein may be implemented in software with a suitable computer programming language. The software modules may be stored on suitable computer-readable medium and used by a computer reading from the computer-readable medium.

Many may have had the experience of placing a book in a bookcase and then sometime—perhaps years—later, going immediately to the book based on the recollection of the size, color and approximate location of the book in the bookcase. The process may be similar to: “I remember that it was a thin but tall blue book and was down somewhere on the lower left of my bookcase. Yes. There it is!”

Both the unique appearance (color, size and shape) and the original action of physically putting the book on the shelf may help to embed or solidity the recollection of where the book is and where the book is located. In the process, one may not need to read all of the titles of every book in the bookcase because one may also have a picture in one's mind of the size, shape, color, and even the type of text on the binding. All of these physical clues may help one to find the book more quickly and directly.

The virtual library file system of the present disclosure may mimic this real world experience by creating a virtual 3D library in which each of the library “books” in the virtual library are link objects, or pointers, to specific computer assets or objects such as files, links, websites, URLs, directories, folders, or the like, on a computer, a network, a local area network, a wide area network, or Internet. A virtual library may refer to a graphical 3D representation of a virtual library file system. In the virtual library, a user may navigate in 3D, pan in 4π steradians, and move a viewpoint high or low. All of the “books” on the shelves (which represent and correspond to specific computer assets or objects) may be individually placed on the shelves by the user.

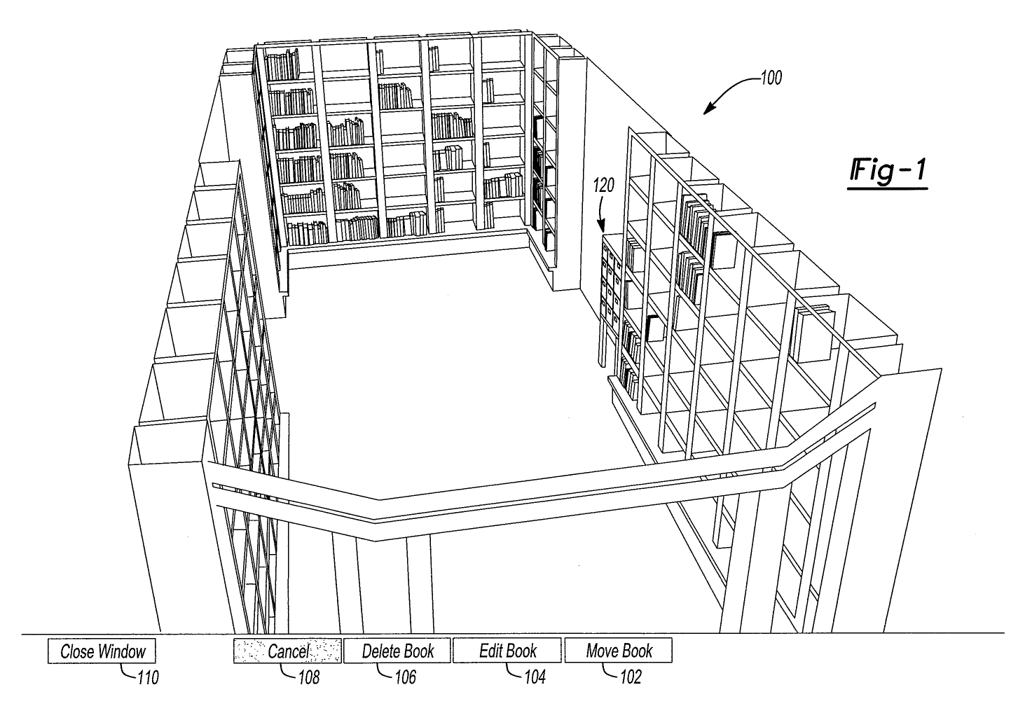

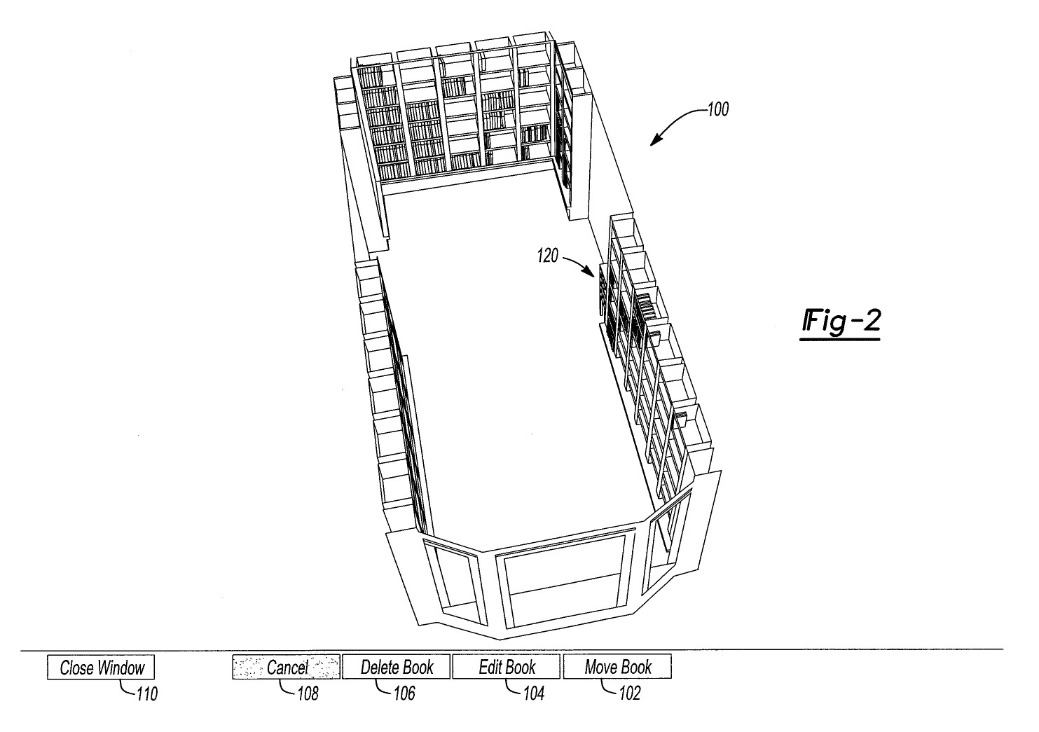

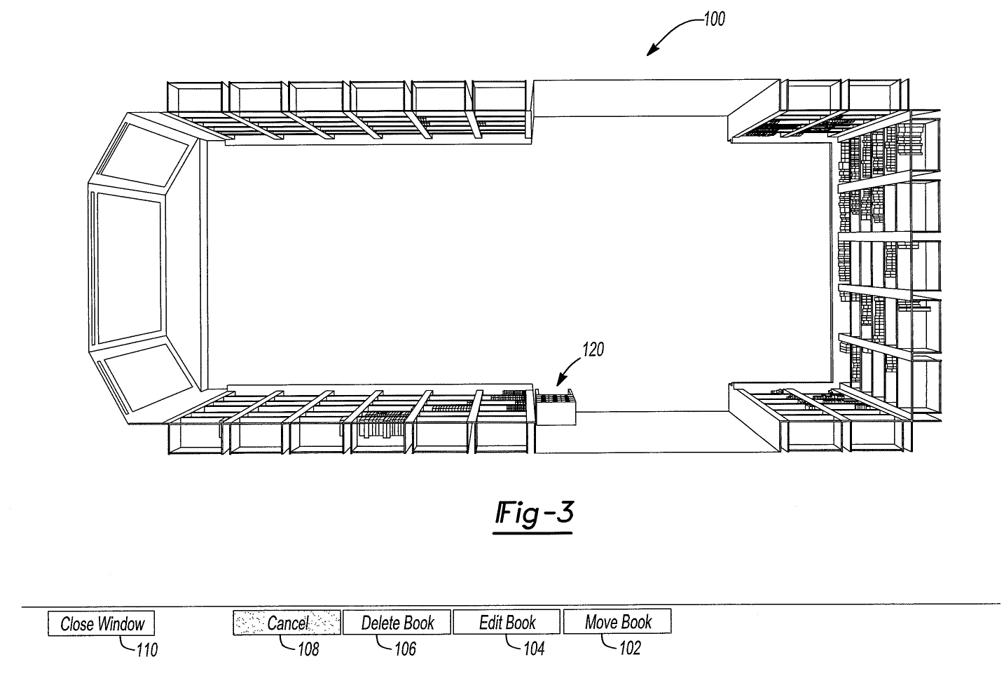

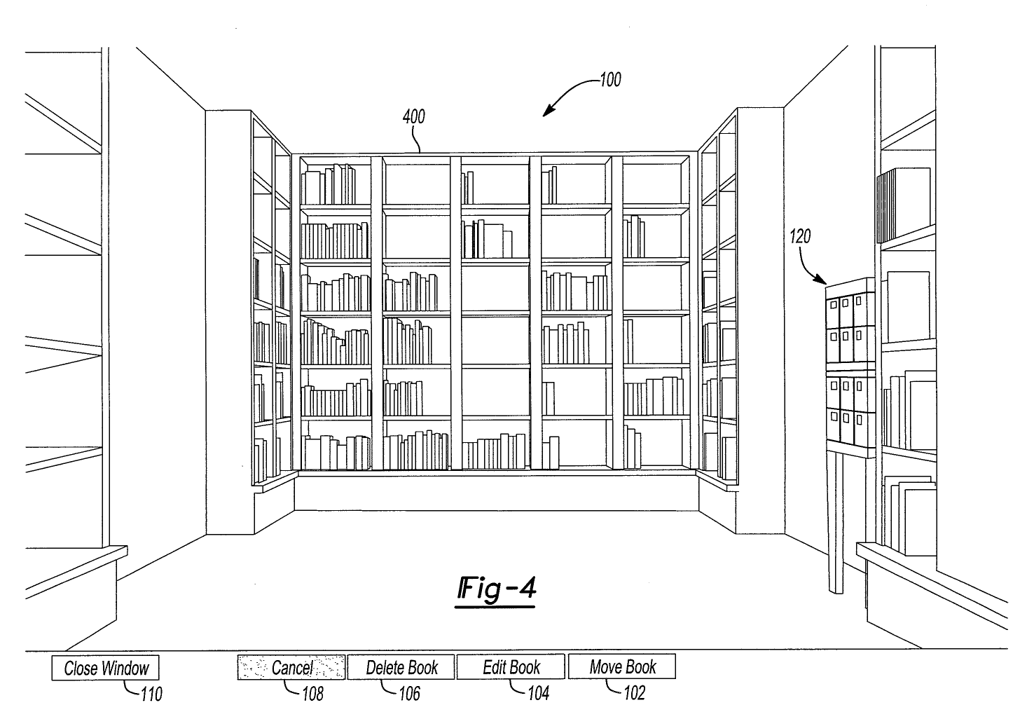

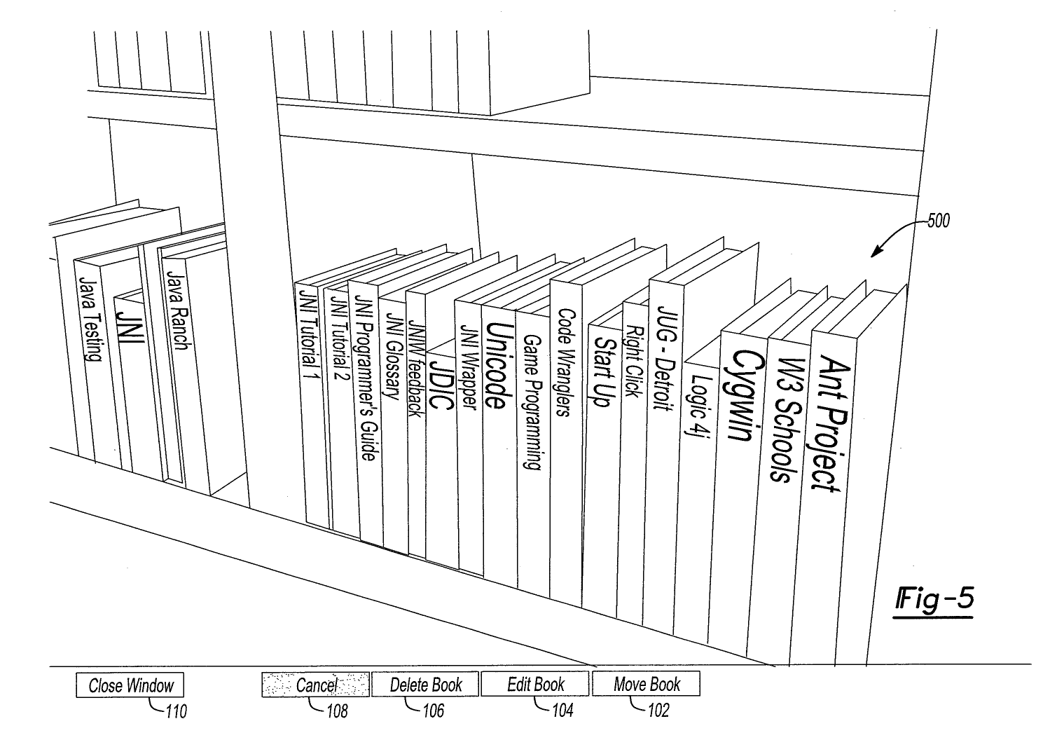

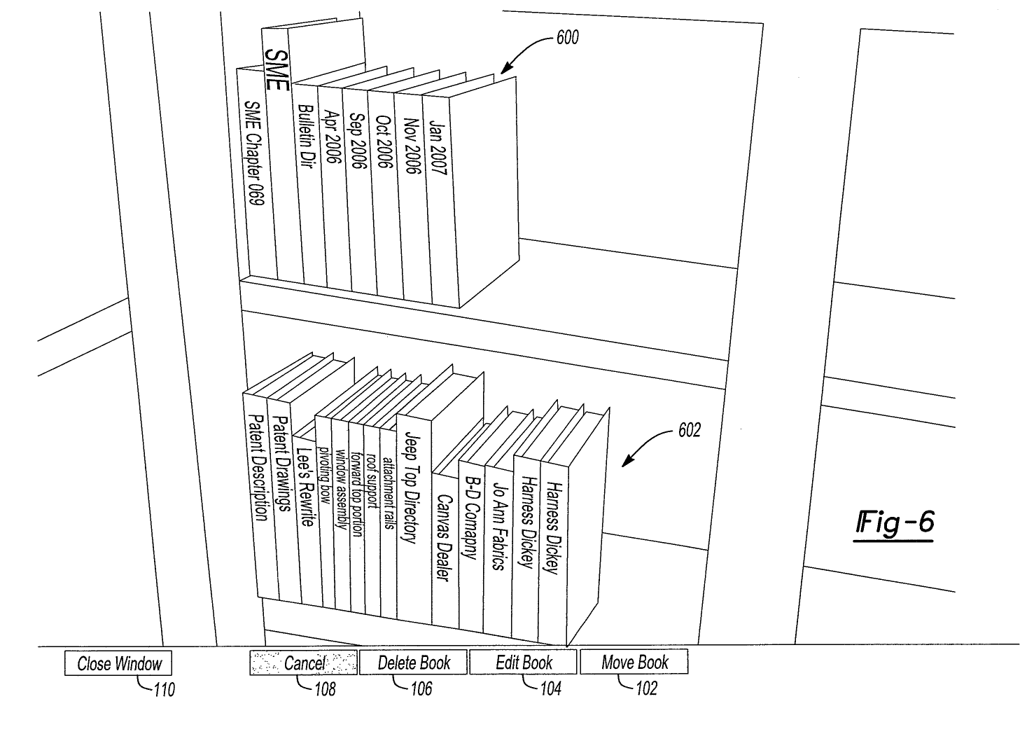

With reference to FIGS. 1 to 6, various screen-shot views of a virtual library 100 are provided. Specifically, FIGS. 1 to 3 provide overhead and perspective views of virtual library 100. FIG. 4 provides a view from within virtual library 100, with a point-of-view perspective directed toward a particular bookshelf 400 within virtual library 100. FIG. 5 provides a view of a bookshelf with a number of “books” 500 which represent and correspond to various computer assets or objects. FIG. 6 likewise provides a view of a bookshelf with two book shelves shown with a number of “books” 600, 602 which represent and correspond to various computer assets or objects.

While viewing or using a particular file, link, website, URL, directory, folder, or the like, a user may decide to create a book to correspond with the particular file, link, website, URL, directory, folder, or the like for placement in the virtual library. The user may right-click on an icon associated with the particular computer object or asset, a file for example, and select an option to “Send” the file to the virtual library file system. The user may also right-click anywhere on a currently displayed web page and select an option to “Send” the file or URL to the virtual library file system. A dialog box, discussed in further detail below, may open giving the user various options with respect to the characteristics of the book that will correspond with the selected file, including height, thickness, color, and/or texture of the book. The user may also enter a short summary of the contents of the file. When satisfied with the book parameters and characteristics, a graphical representation of the virtual library file system may be launched on the screen. The user may then navigate through virtual library 100 to a particular bookcase 400 and book shelf for placement of the book. After selecting the location, the book may be placed on the shelf.

While navigating virtual library 100, various control buttons 102-110 may be provided. For example, a user may select a move book button 102 to move the location of a book within virtual library 100. A user may select an edit book button 104 to edit a summary or graphical characteristics, i.e., height, thickness, color, and/or texture of a book within virtual library 100. A user may select a delete book button 106 to remove a book from virtual library 100. A user may select a cancel button 108 to cancel a particular operation. A user may select a close window button 110 to close or minimize the virtual library file system and virtual library 100.

Once a book is created to correspond or point to a computer asset or object, such as a file, a user has several mental queues with which to remember the book for finding at a later date, including: the general area of the library, the bookcase, the shelf, the position on the shelf, the shape and color of the book and, of course, the title.

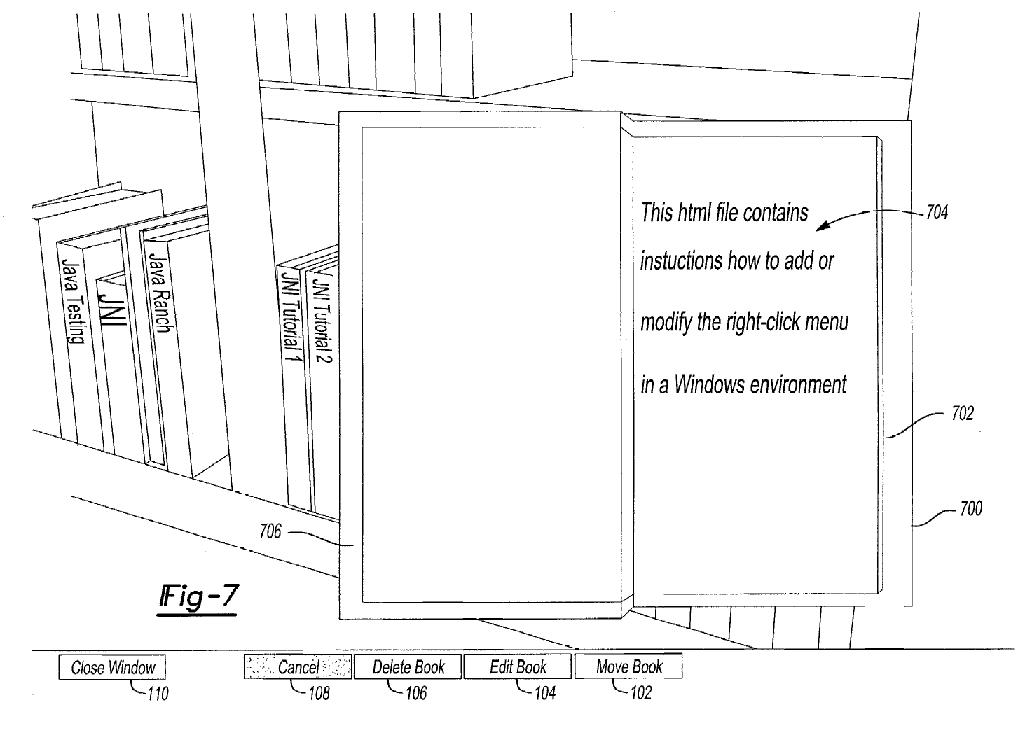

While in virtual library 100, when a book is selected, it is removed from the shelf and brought to the forefront as an open book. The title page 702, now visible, contains the short summary description of the related file. With reference to FIG. 7, an open book 700 is shown with a short summary 704. For example, summary 704 for the selected book 700 provides: “This html file contains instructions how to add or modify the right-click menu in a Windows environment.” If the summary 704 confirms that this is indeed the file the user is seeking, a single click on title page 702 will launch the file with the appropriate application associated with the file-type. For example, if the file is a word processing file, the file may be launched with the appropriate word processor. From within virtual library 100, a single click on a shelved book may move the selected book to the forefront with an open cover, revealing the title page 702 with summary 704. A single click on the facing title page 702 (on which the summary appears) may cause the associated file to be launched with its associated application. A single click on the book's inside front cover 706 may close the book and return it to the shelf.

If the user chooses not to launch the file, a click on the book's cover 706 may close the book and return it to its location on the shelf.

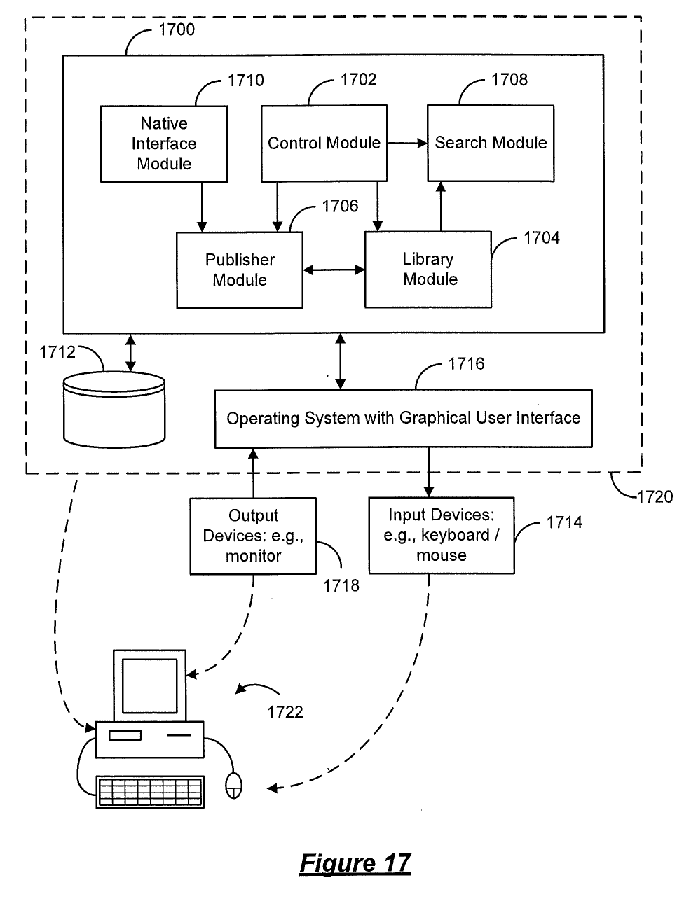

With reference to FIG. 17, the virtual library file system 1700 may include a number of modules, including a control module 1702, a library module 1704, a publisher module 1706, and a search module 1708. The virtual library file system 1700 may also include a native interface module 1710. Virtual library file system 1700 may access a file storage unit 1712, including a computer readable medium for storing software for the virtual library file system 1700 and the various modules as well as data related to the various books stored within virtual library file system 1700. Virtual library file system 1700 may communicate with an operating system with Graphical User Interface 1716. Virtual library file system 1700, file storage unit 1712, and operating system with graphical user interface may be used in conjunction with a computer 1722. Computer may be a desktop computer, a laptop computer, a pda, Smartphone, etc. Computer 1722 may include output devices 1718 such as a monitor or screen and input devices 1714, such as a keyboard, mouse, touch screen, and the like.

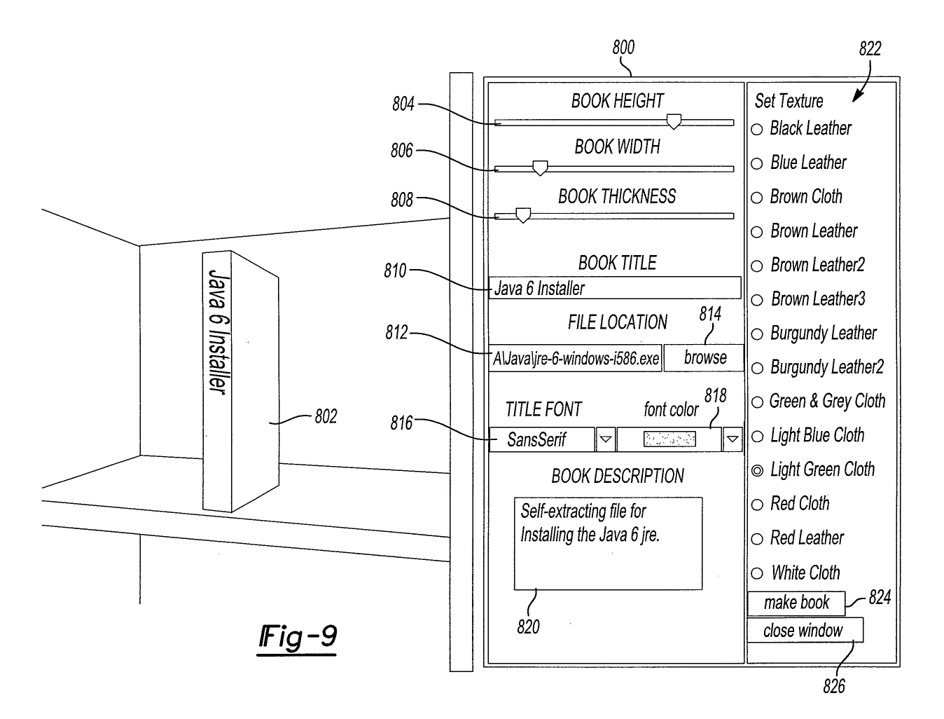

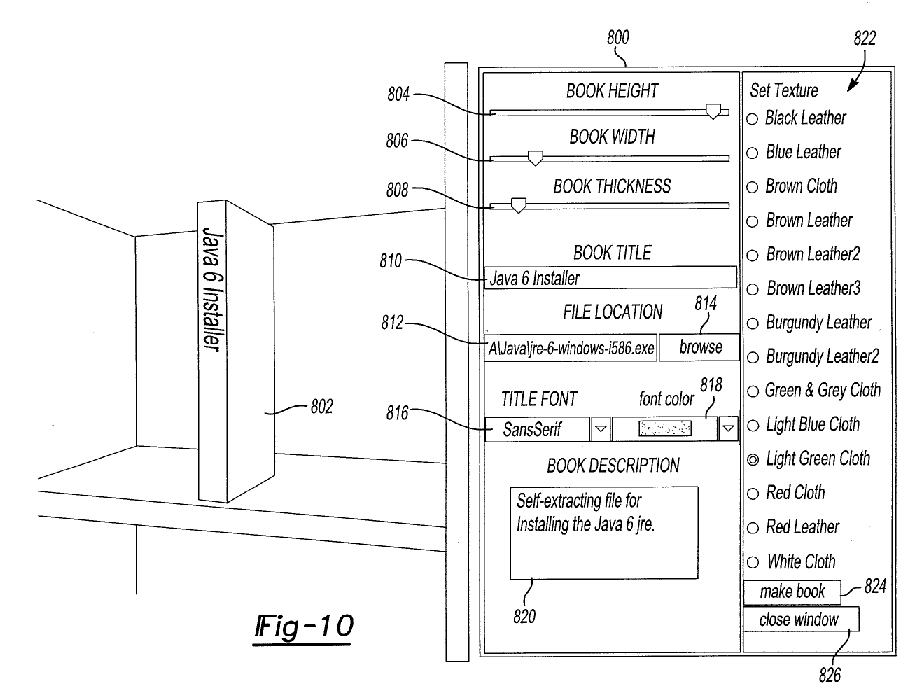

With reference again to FIGS. 1 to 11 and with continued reference to FIG. 17, a user can freely navigate the virtual space of virtual library 100 from a first-person-perspective. Virtual library 100 may contain virtual bookcases 400 and bookshelves, upon which virtual books 500, 600, 602 may reside. Input devices 1714, such as a mouse and/or keyboard, or some combination thereof, may be used to navigate through the virtual space. The graphical interface of the virtual library may be driven by library module 1704.

On the initial launch of library module 1704, the virtual library's bookshelves may be empty. Over time, a user may populate the virtual library 100 by placing each book on the various shelves as described below.

Books 500, 600, 602 may be added to the virtual library 100 from the native operating environment of the computer or from the virtual library file system 1700 itself. The native operating environment, for example Windows™, may typically display each file or directory as an icon within the native operating environment. The user may right-click on any selected icon, causing a right-click menu to appear. By selecting a “Send” function from the available menu options, a dialog box for setting the book's appearance properties may appear. A full directory path to the selected file may automatically appear in the file path text field.

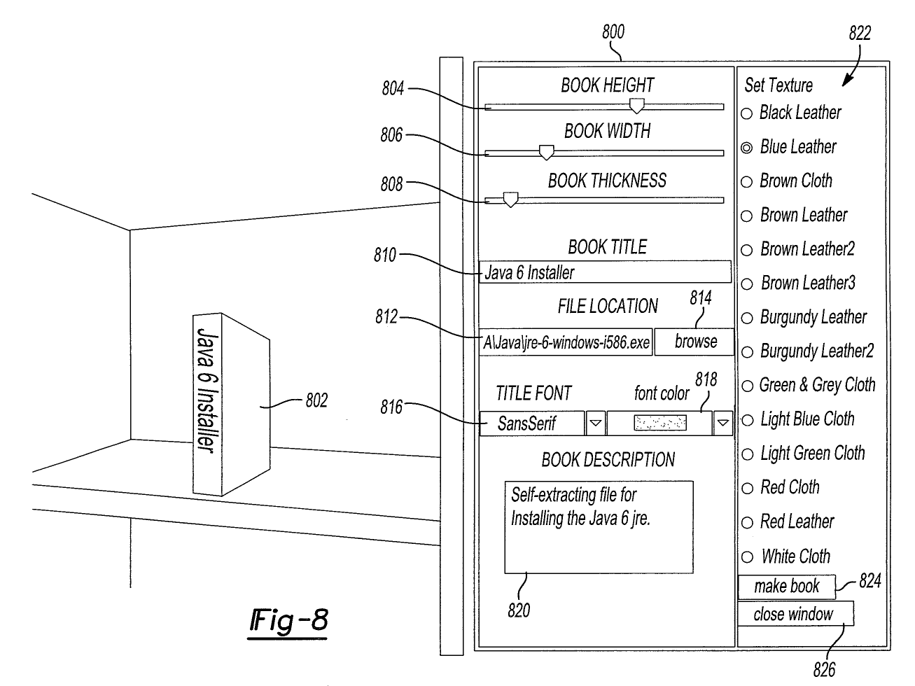

With reference to FIGS. 8 to 10, a dialog box 800 for setting the book's appearance properties is shown. Dialog box 800 may include a visual representation of the new book 802 in an adjacent window. The user may then customize the book's properties which include height, width, thickness, texture, color, title font, and title font color. The visual representation of the book 802 adjusts in real-time to any changes in the selected properties. For example, a user may adjust a book height with a book height slider 804. A user may adjust a book width with a book width slider 806. A user may adjust a book thickness with a book thickness slider 808. A user may input a book title with a book title text box 810. A user may edit a file location with a file location text box 812. A user may browse for a particular file location by selecting a browse button 814. A user may input a title font with a title font drop down box 816. A user may input a font color with a font color drop down box 818. A user may edit a book description with a book description text box 820. A user may select a book's color and texture with various color/texture radio buttons 822. A user may make the configured book by selecting a make book button 824. A user may close the dialog box 800 by selecting a close window button 826.

In addition to the outward appearance of the book, the first page of the book (seen when the book's cover is opened) may also be customized. This may be done by filling in some descriptive text in the available text box 820. When the user is satisfied with the book's appearance and properties, the user may then select the “make book” button 824 in the dialog 800. Selecting the make book button 824 may launch library module 1704. The user may then navigate through virtual library 100 and select the shelf location on which to place the new book 802.

The user may browse virtual library 100 either to shelve a newly created book or to browse and retrieve a previously created book from the library. Navigation through virtual library 100 may be achieved by a combination of mouse and keyboard actions. The navigation abilities may include 3D movement in any direction, panning in 4π steradians, and the ability to raise or lower the view point. Navigation may be restricted to the library floor plan and may not allow passage through “solid” objects. The navigation controls may be consistent with those of first-person-shooter (FPS) video games.

The navigation controls may include look right, look left, look up, and look down and may be accomplished by moving the right-click mouse right, left, back, forward. Additionally, navigation may include move forward, move back, slide right, and slide left and may be accomplished by pressing the “↑”, “↓”, “→”, and “←” buttons respectively, or by pressing the “w”, “s”, “a”, and “d” buttons respectively. Additionally, navigation may include moving the viewpoint up or down by pressing the shift or Ctrl keys, respectively.

For shelving a newly created book, library module 1704 may be launched automatically and the view platform may be placed at the last view position. The user may then navigate through virtual library 100 and select a position in one of the bookcases on which to shelve the book. The position may be selected by means of a mouse left-click on a shelf area or on an existing book. The user may be free to use any organizing scheme he or she wishes. Some rules, however, may be used for placement of the books on the shelves. For example, books may not be free-standing. Also, stacking may begin from the left hand side of each shelf and added left-to-right. Also, books may be inserted to the left of already shelved books (provided there is room on the shelf,) by shifting the free-end of the stack to the right as appropriate. Also, previously shelved books can be repositioned by launching a “move book” option by selecting move book button 102. Also, the properties of previously existing books (including file links) may be modified by selecting the “edit book” option with the edit book button 104. Also, existing books may be removed from the virtual library by selecting the “delete book” option with delete book button 106.

In this way, the virtual library file system 1700 associates visual and spatial properties, that are natural to a human environment, to computer files, which are natural to a computer or electronic environment. The act of giving a file a unique, yet familiar appearance coupled with the act of moving through the virtual 3D environment to a particular location and physically putting the book on a shelf helps to ingrain in the user's mind the memory of where the book representing the file resides. When the user incorporates some sense of organization in placing the books on the shelves, the experience of browsing the files is much like the real experience of browsing books in a real library or bookstore. That is, other books in the same vicinity are likely to represent files of related or similar content. Thus, the organization of the books is always entirely controlled by the user in a way that corresponds to a human environment.

Virtual library may also contain a card-catalog 120 accessible to the user. Information in card catalog 120 may be updated when a book is created or updated. Card-catalog 120 may be searched by key word and may contain information and options including: (1) The filename and complete path or the file for which the book acts as a pointer; (2) The text summary of the file contents; (3) The bookcase and shelf location in the library; and/or (4) A link that will launch the file with its associated application.

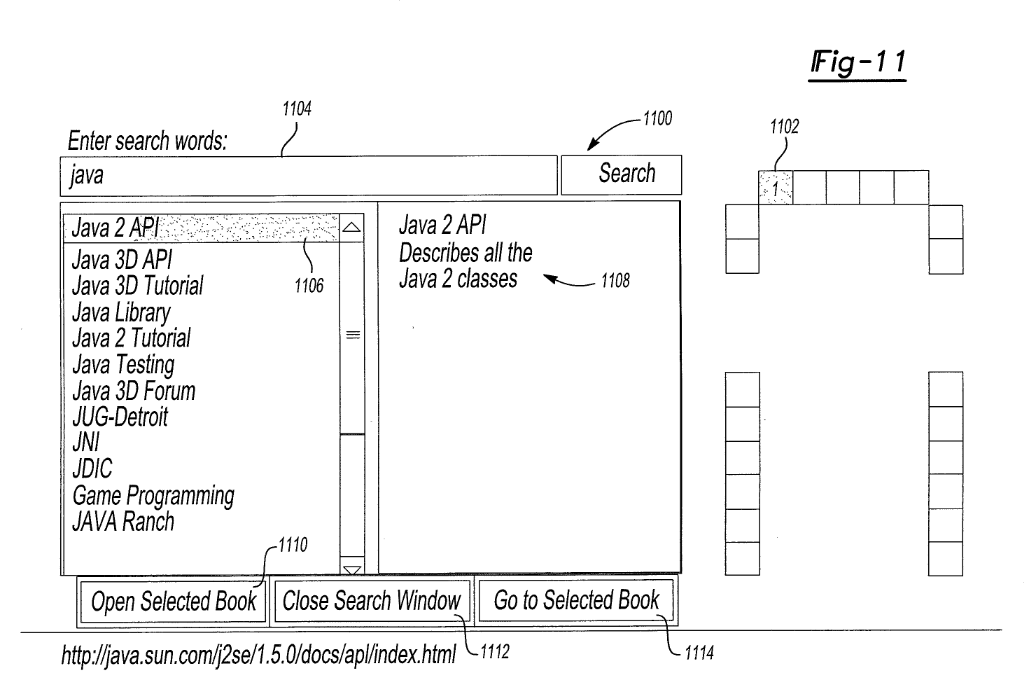

With reference to FIG. 11, a screen-shot of a search window 1100 of a card catalog 120 is shown. Search words may be entered in a search text box 1104 and a list of possible search matches may be listed. When a particular match 1106 is selected, a short summary 1108 of the selected match may be provided. In addition, a location 1102 of the book in virtual library 100 may be shown. For example, in FIG. 11, the book may be found on the indicated bookcase at location 1102. Further, the individual shelves of the bookcase may be numbered. In FIG. 11, for example, the book may be found on shelf “1” of the indicated bookcase location 1102. Together, the graphical image and the indicated number may direct the user to the particular bookcase and shelf where the book may be found. To open the selected book, the user may select an “Open Selected Book” button 1110. When the Go To Selected Book button 1114 is selected, a user's view may be moved to a position near or adjacent to the selected book.

The layout and configuration of virtual library 100 may be user configurable. For example, there may be free-standing bookcases within the virtual library or, alternatively, all the bookcases may be located along the walls. In this way the user may determine a floor plan, windows, bookcase locations etc., The user may be able to set a maximum book capacity for the library. The user may be able to select from a number of physical architectures for the virtual library, for example, Classical, Gothic, Renaissance, Modern, etc. In addition, a user may be able to configure their own physical architecture. The user may also be able to configure the view to the outside from the library windows. For example, the library may be implemented as floating in the clouds. The background may also be configurable to include the virtual library floating in space, on the ocean, in a forest, or the user could provide his/her own picture of the surroundings.

The library module may be designed to run in background at all times. Thus, its demand for CPU and RAM resources may remain small, so that it does not interfere with normal computer operation.

The virtual library file system may include the ability to “create”, “open”, “save” or “save as” additional virtual library file system data files. In other words, users may be able to maintain more than one virtual library. The virtual libraries may be linked such that a user may navigate to “other rooms” or to “other libraries.” All book data (i.e., appearance, location, title, description, link, etc.) may be stored in a data file corresponding to a particular library or room of a library. Additional rooms or libraries may correspond to additional data files. Further, multiple users of a single computer may maintain separate libraries on the same computer.

A library may also be configured as a multi-user library. In such case, many users may share a single virtual library. For example, a business or university may maintain a multi-user virtual library for dissemination of company-wide or university-wide information. In this way, employees or students may be able to easily access information commonly required. As an example, all files related to a certain project may, in reality, be scattered all over the local area network or even the wide area network. By utilizing a virtual library file system, all of the related files may appear in close proximity in the virtual library even though the file-links may be associated with files all over the world. If the virtual library is logically organized, it would enable users to locate a wide variety of necessary information with few obstacles.

In a multi-user virtual library, sections of the virtual library may be labeled. For example, a reasonably large (so as to be legible from a distance) free-floating, transparent sign may be used. A user may operate a toggle button to determine whether signs are visible or not to the user.

A multi-user virtual library may also require administrator or librarian capabilities that are forbidden to general users. For instance, the ability to add or delete books from the library may be restricted to the librarian. Also, some books may require restricted access by entry of password only.

A current trend in traditional libraries is to eliminate “open stacks.” That is, some libraries may forbid users from browsing the stacks and instead must find their book through the library's card-catalog data base. The user then has to ask a desk-person to retrieve the selected titles. Naturally, there is a lot of opposition on the part of library's customers to that idea. There are clearly many advantages to being able to browse the books “in person.” One reason is that other books of similar topic are shelved in the same general area in the library and it is convenient to browse other unexpected titles.

A virtual library file system may offer a practical solution to this dilemma as a virtual representation of a traditional library, with all of the books placed in the same corresponding virtual space location and having the same appearance as the actual book. Each of the virtual books may be linked to an e-text version of the real book or to display some significant summary information of it. In this way, a user may browse the aisles of the virtual library in much the same way as browsing a traditional library. Clicking a “check-out” button on a selected book may send a signal to the desk to retrieve the hard-copy check-out.

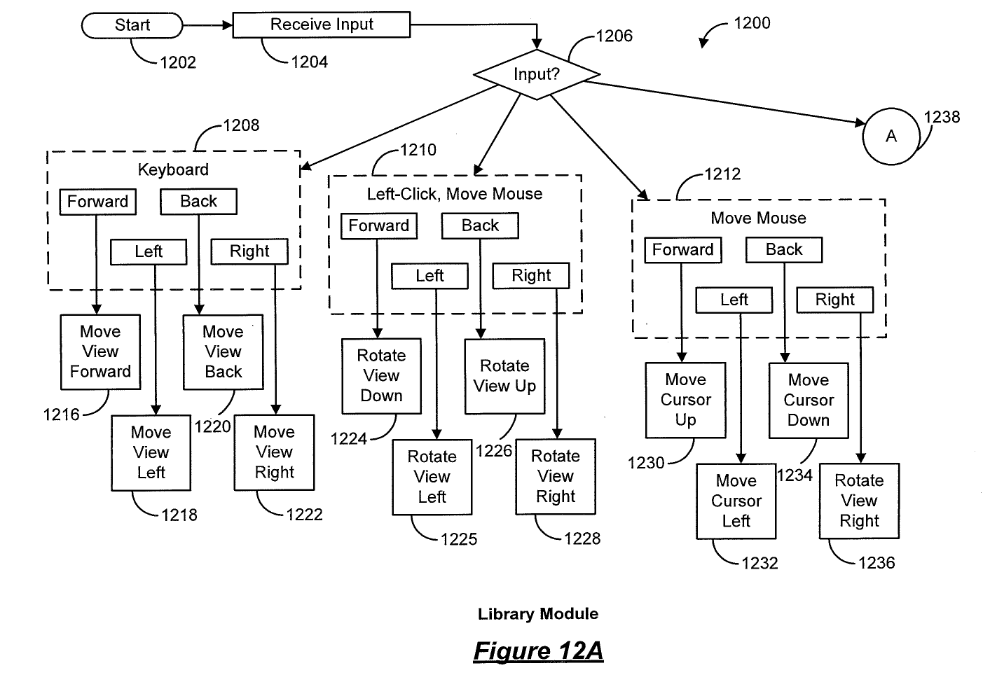

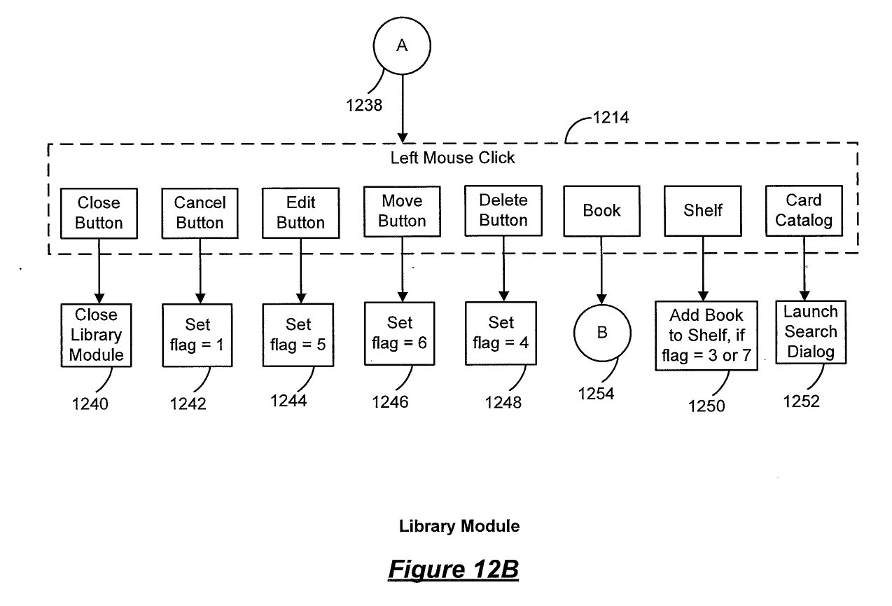

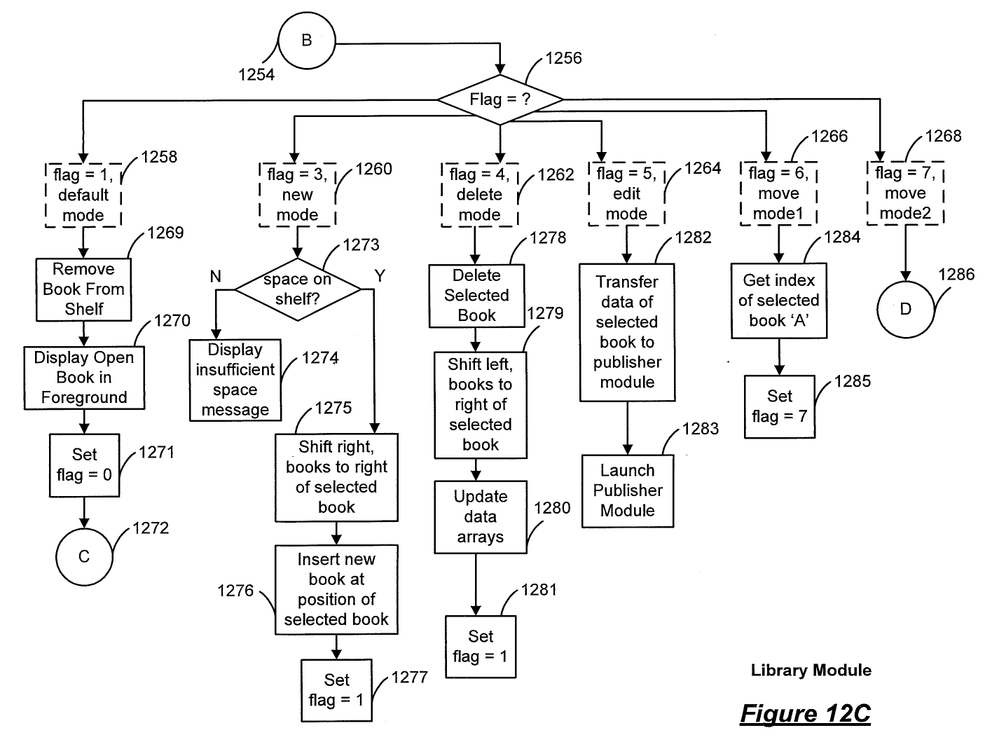

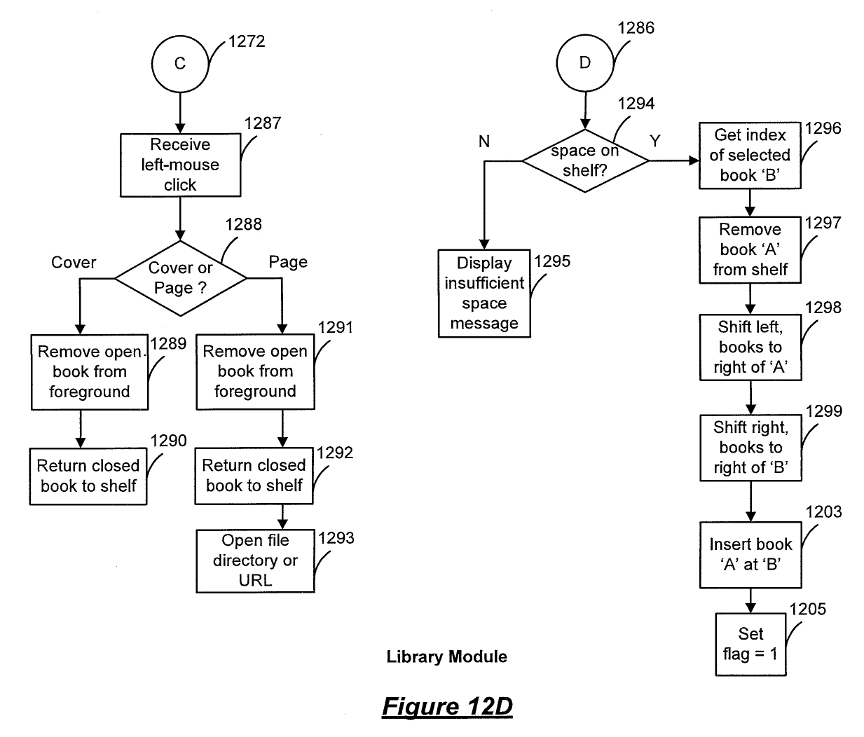

With reference to FIG. 12, an operating algorithm 1200 for library module 1704 is shown. User input may be received in boxes shown within dashed lines. Library module 1704 may begin in step 1202. In step 1204, library module 1704 may receive input. After executing the various operations indicated, library module 1704 may again return to step 1204 to receive additional input. In step 1206, library module may determine whether the input is keyboard input, left-click with mouse move input, mouse move input, or left mouse click. When the input is keyboard input, library module 1704 may proceed to step 1208. When the input is left-click with mouse move input, library module 1704 may proceed to step 1210. When the input is mouse move input, the library module proceeds to step 1212. When the input is left mouse click, library module 1704 may proceed to step 1238, and subsequently to step 1214 (shown in FIG. 12B, Circles with enclosed letters indicate a portion of the flow chart continued on another Figure).

When in step 1208, library module 1704 receives keyboard navigational input, library module moves the view forward, back, left or right appropriately in steps 1216 to 1222 as indicated. The keyboard input may comprise directional arrow key depressions. Alternatively, designated letters of the keyboard may be used for the various directions. In this way, Library module 1704 may appropriately move view forward, move view back, move view left, or move view right in response.

When in step 1210, library module 1704 receives a left-click with mouse move input, i.e., a left-click and hold with mouse movement, library module 1704 may rotate the view down, up, left, or right in steps 1224 to 1228 as indicated. In this way, library module 1704 may receive various navigational mouse input commands, such as left, right, forward, and back which may cause the view to be rotated left, right, down, or up, respectively.

When in step 1212, library module 1704 receives mouse movement input, library module may move a cursor up, down, left or right in steps 1230 to 1236 as indicated.

With reference to FIG. 12B, library module 1704 may receive various left-mouse-click actions, including a close action, a cancel action, an edit action, a move action, a delete action, a book action, a shelf action, or a card catalog action. When library module 1704 receives a close book button action, library module 1704 may close library module 1704 in step 1240. When library module 1704 receives a cancel button action, library module 1704 may set a flag to 1 in step 1242. When library module 1704 receives an edit button action, library module 1704 may set the flag to 5 in step 1244. When library module 1704 receives a move button action, library module 1704 may set the flag to 6 in step 1246. When library module 1704 receives a delete button action, library module 1704 may set the flag to 4 in step 1248. As can be appreciated, other flag value designations may be used in accordance with the present disclosure.

When library module 1704 receives a shelf action, library module may add a book to the shelf if the flag is set to 3 or 7 in step 1250, as discussed in further detail below. When library module receives a card catalog action, library module 1704 may launch a search dialog in step 1252.

When library module 1704 receives a book action, library module 1704 may proceed to step 1254 and to step 1256, shown in FIG. 12C. When a book action is received, library module 1704 may check a status of the flag in step 1256. Based on the status of the flag, library module 1704 may enter a default mode in step 1258, a new mode in step 1260, a delete mode in step 1262, an edit mode in step 1264, a first move mode in step 1266, or a second move mode in step 1268, as appropriately indicated by the flag.

When in the default mode in step 1258, library module 1704 may remove a book from a shelf in step 1269 and display the open book in the foreground in step 1270. Library module 1704 may then set the flag to 0 and proceed to step 1272 and subsequently to step 1287 as shown in FIG. 12D.

With reference to FIG. 12D, when library module 1704 receives a left-mouse click in step 1287, library module 1704 may determine whether the mouse click corresponds to a cover selection or a page selection in step 1288. When the cover is selected, library module 1707 may remove the open book from the foreground in step 1289 and return it to the shelf in step 1290. When a page is selected, library module 1704 may remove the open book from the foreground in step 1291, return the closed book to the shelf in step 1292, and open a file directory or URL in step 1293.

With reference again to FIG. 12C, when library module 1704 is in the new mode in step 1260, library module 1704 may check for sufficient space on a shelf in step 1273. When there is sufficient space, library module 1704 may shift books to the right of the selected book in step 1275 and insert the new book at the position of the selected book in step 1276. When there is insufficient space on the shelf, library module 1704 may generate a message indicating there is insufficient space and prompting the user to select a different shelf in step 1274.

When library module 1704 is in delete mode in step 1262, library module 1704 may delete the selected book in step 1278, and shift books to the left in step 1280. Library module 1704 may then update data arrays stored in a computer readable medium database 1712, shown in FIG. 17, to reflect the change in step 1280. Library module 1704 may then set the flag to 1 in step 1281.

When library module 1704 is in edit mode in step 1264, library module 1704 may transfer data of the selected book to publisher module 1706 in step 1282 and launch publisher module 1706 in step 1283, as discussed in more detail below.

When library module 1704 is in the first move mode, or move mode 1, library module 1704 may get an index of a selected book “A” in step 1284 and may set the flag to 7 in step 1285.

When library module 1704 is in the second move mode, or move mode 2, library module may proceed to step 1286 and subsequently to step 1294, as shown in FIG. 12D. In step 1294, library module 1704 may determine whether space is available on the shelf. When space is insufficient, library module 1704 may display an insufficient space message in step 1295. When space is available, library module 1704 may get an index of selected book “B” in step 1296, remove selected book “A” from the shelf in step 1297, shift left the books previously to the right of “A” in step 1298, shift right the books previously to the right of “B”, including “B” in step 1299, and insert “A” at the original location of “B” in step 1203. In step 1205, library module 1704 may set the flag to 1. In this way, “A” may be inserted to the left of “B” and “B” may finish to the right of “A”.

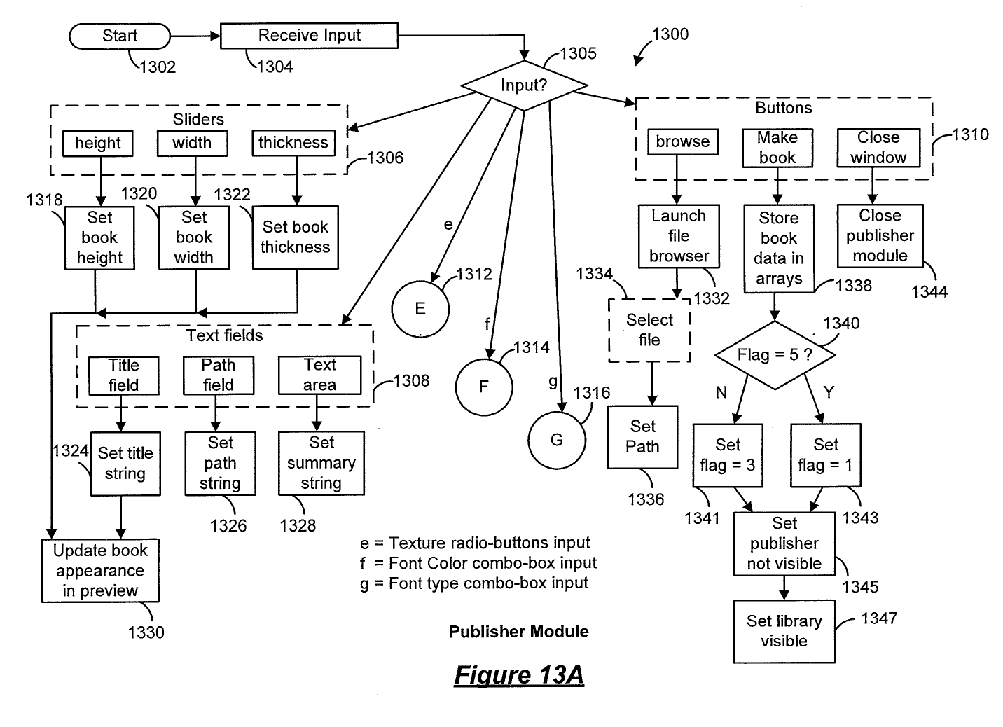

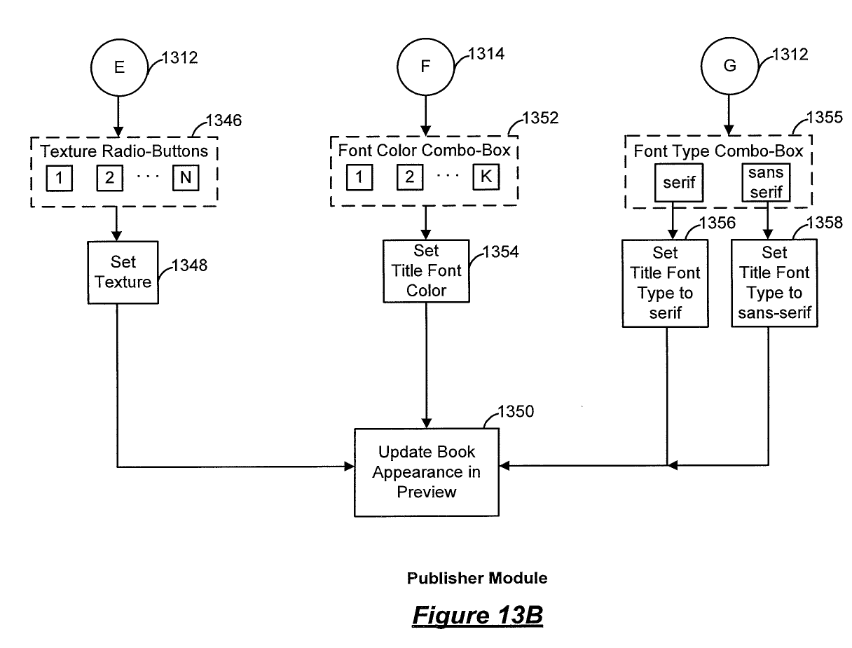

With reference to FIG. 13, an operating algorithm 1300 for publisher module 1706 is shown. Publisher module 1706 may start in step 1302 and may receive in put in step 1304. After executing appropriate actions based on the received input, publisher module 1706 may return to step 1304 to receive additional input, as appropriate. In step 1305, publisher module 1706 may determine the type of input received. When publisher module 1706 receives slider input, publisher module may proceed to step 1306. When publisher module 1706 receives text field input, publisher module 1706 may proceed to step 1308. When publisher module receives buttons input, publisher module may proceed to step 1310. When publisher module 1706 receives texture radio-buttons input, publisher module may proceed to step 1312 and subsequently to step 1346, as shown in FIG. 13B. When publisher module 1706 receives font color combo-box input, publisher module may proceed to step 1314 and subsequently to step 1352, as shown in FIG. 13B. When publisher module 1706 receives font type combo-box input, publisher module 1706 may proceed to step 1316 and subsequently to step 1355 as shown in FIG. 13B.

By manipulating the sliders, radio buttons, and combo-boxes, as described above with reference to FIGS. 8 to 10, a user may determine the physical appearance of a book. For example, when slider input is received in step 1306, publisher module may set a book height, book width and book thickness in steps 1318 to 1322 and may update a book appearance in preview in step 1330. When text field input is received in step 1308, publisher module 1706 may set a title string, path string, or summary string in steps 1324 to 1328. In this way, by editing the text fields, a user may determine the title, path, and text summary associated with the book

With reference to FIG. 13B, when texture radio buttons input is received in step 1346, publisher module 1706 may set a book texture in step 1348 and update a book appearance in preview in step 1350. When font color combo-box input is received in step 1352, publisher module 1706 may set a title font color in step 1354 and update a book appearance in preview in step 1350. When font type combo-box input is received in step 1355, publisher module 1706 may set a title font appropriately in steps 1356 to 1358. As can be appreciated, any type of font may be used in accordance with the present disclosure.

By selecting appropriate buttons, a user may determine whether to place the book on a shelf. By pressing the “make book” button, the library module may be launched in “new” mode which may allow the user to select the placement of the book on a particular shelf within a bookcase.

With reference again to FIG. 13A, buttons input may be received in step 1310. When a browse button is selected, publisher module 1706 may launch a file browser in step 1332. A file may then be selected in step 1334 and a path set in step 1336. When a make book button is selected in step 1310, book data may be stored appropriately in the data arrays in step 1338. In step 1340, publisher module 1706 may determine whether the flag is set to 5. When the flag is set to 5, publisher module then sets the flag to 1 in step 1343. When flag is not set to 5, publisher module sets the flag to 3 in step 1341. In step 1345, publisher module 1706 is set to not visible. In step 1347, library module 1704 is set to visible. In step 1310 when a close window button is selected, the publisher module is closed in step 1344.

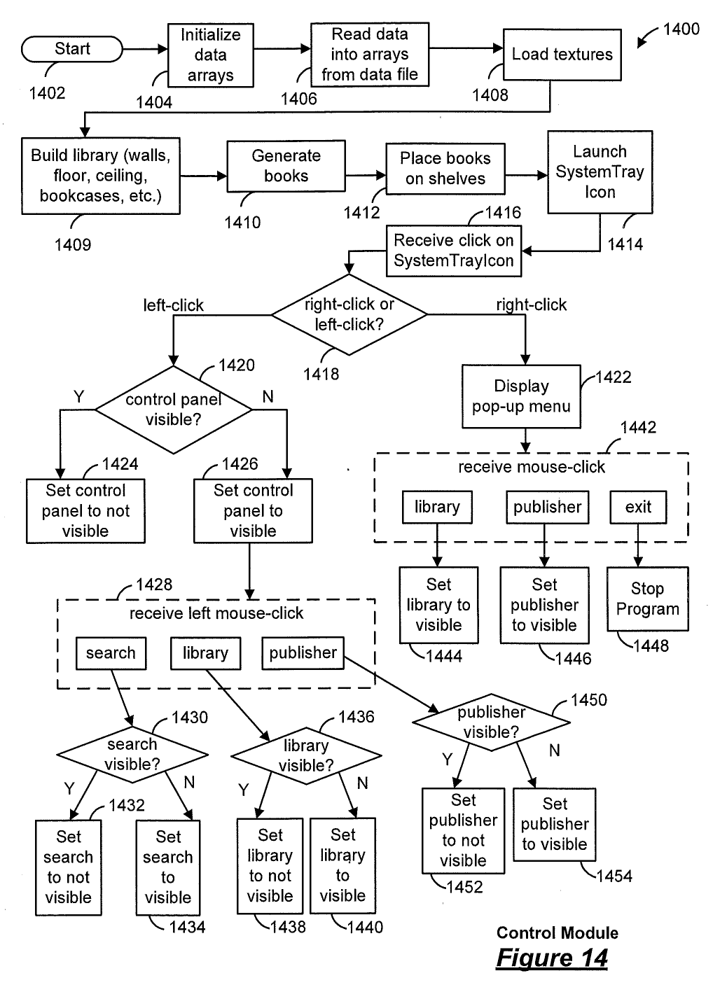

With reference to FIG. 14, an operating algorithm 1400 for control module 1702 is shown. Control module 1702 may “build” virtual library 100 and populate the shelves according to a virtual library data file stored in database 1712, or stored remotely and accessible to control module 1702 over a network. When launched in step 1402, control module 1702 may initialize data arrays in step 1404, read data into the data arrays from the data file in step 1406, load textures in step 1408, build the library walls, floor, ceiling, bookcases, etc. in step 1409, generate books in step 1410, and place the books on the shelves in step 1412. Control module 1702 may launch a system tray icon in step 1414 and wait for either a left click on the system tray icon or a right click on the system tray icon. Control module 1702 may receive mouse click input on the system tray icon in step 1416. Control module 1702 may determine whether a left-click or a right-click was received in step 1418. When a left click is received control module may proceed to step 1420 and may render a control panel visible, when it was previously not visible in step 1426, or render a control panel not visible, when it was previously visible in step 1424. When the control panel is set to visible in step 1426, control module may wait for a library selection, a publisher selection, or a search selection in step 1428. When a library selection is received, control module 1702 may render the virtual library visible, when it was previously not visible in step 1440, or not visible when it was previously visible in step 1438. When a publisher selection is received, control module 1702 may render a publisher window visible, when it was previously not visible in step 1454 or not visible, when it was previously visible in step 1452. When a search selection is received, control module 1702 may render a search window visible, when it was previously not visible in step 1434, or not visible, when it was previously visible in step 1432.

When a right click is received on the system tray icon in step 1418, a pop-up menu is displayed in step 1422. The pop-up display may include a library option, a publisher option, and an exit option. Control module 1702 may receive a pop-up display selection in step 1442. When the library option is selected, control module 1702 may set the virtual library to visible in step 1444. When the publisher option is selected, control module 1702 may set the publisher window to visible in step 1446. When exit is selected, control module 1702 may end operation in step 1448.

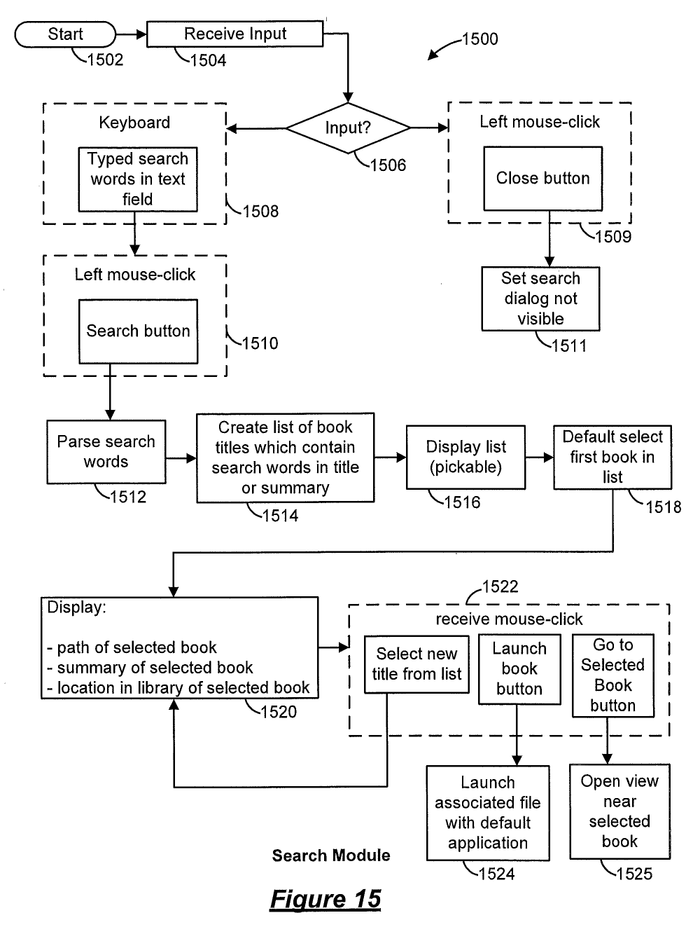

With reference to FIG. 15, an operating algorithm 1500 for a search module 1708 is shown. Search module 1708 may receive input in step 1504. In step 1506, search module 1708 may determine whether the input is keyboard input or left mouse-click input. When the input is keyboard input, search module 1708 may proceed to step 1508. Search words from keyboard may be input. When a search button is pressed in step 1510, search module 1708 may parse search words in step 1512 and create a list of book titles which contain search words in the title or in the summary in step 1514. Search module may then display the generated list in step 1516. The first book in the list may be selected as the default selection in step 1518. Search module 1708 may then display properties of the selected book including a path, a summary, and a display location in step 1520. A user may then select another book from the search list, select the “Launch Book” button, or select the “Go to Selected Book Button” in step 1522. When the launch book button is selected, the file associated with the selected book is opened with the appropriate application in step 1524. When the “Go To Selected Book button is selected”, the user's view may be moved to a position near or adjacent to the selected book. For example, the user's view may be placed directly in front of the selected book within the virtual library 100. When a new title is selected, search module may return to step 1520 to display the path, summary, and location.

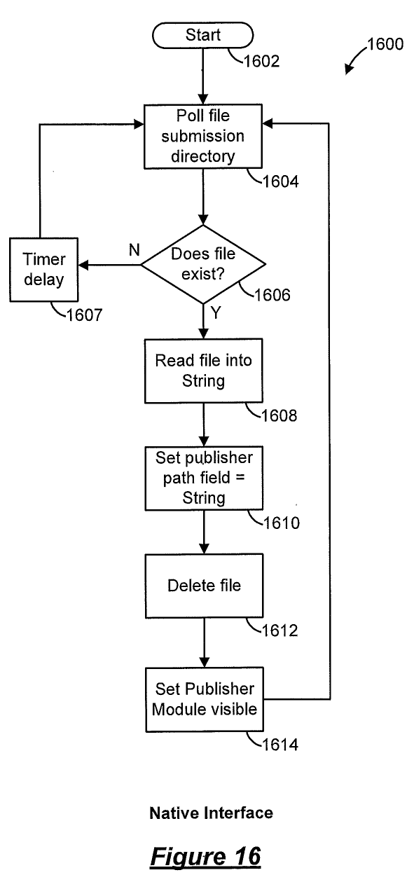

With reference to FIG. 16, a native interface module 1710 is shown. Native interface module 1710 repetitively polls a submission directory in step 1604. A submission directory includes a predetermined directory location. When a user selects a “Send” option from the computer's native operating system, the native operating system may place a link to the file in the predetermined directory location. When the link is placed in the predetermined directory location, the file is detected on the next polling iteration in step 1606. Thus, when a link to the file is detected in step 1606 in the poll file submission directory, native interface module 1710 may open publisher module 1706 to allow the user to select appropriate characteristics and properties to be associated with the file. In step 1608, the file may be read into a string. In step 1610, a publisher path field may be set to the string. In step 1612, the file may be deleted from the poll file submission directory. In step 1614, publisher module 1706 may be set to visible. Native interface module 1710 may then return to step 1604.

In this way, virtual library file system 1700 creates and maintains a graphical representation of user configured books associated with various files, links, websites, URLs, directories, folder, any other computer objects or assets, or the like. The user is provided with several mental queues with which to remember books for finding at a later date, including the general area of the library, the bookcase, the shelf, the position on the shelf, the shape and color of the book and, of course, a title. Thus, the user is able to more efficiently and conveniently store and locate their electronic data in the virtual library for retrieval at a later date. Virtual library file system 1700 allows the user to maintain electronic data in a format that is intuitively compatible with the user's every day world, instead of the traditional, and sometime counter-intuitive, hierarchical file system.

What is claimed is:

1. A graphical display system comprising:
a publisher module that receives a plurality of link objects for display in a virtual library, that generates a plurality of virtual book objects, each virtual book object corresponding to a link object of said plurality of link objects, and that allows configuration of virtual characteristics associated with said each virtual book object, said virtual characteristics including at least one of a size characteristic, a color characteristic, and a texture characteristic, each link object of said plurality of link objects being associated with at least one of an electronic file, an electronic directory, an electronic folder, a website, and a uniform resource locator (URL);
a library module in communication with said publisher module that displays said plurality of virtual book objects, within a predetermined format including a plurality of virtual shelves for displaying said virtual book objects;
a computer readable medium that stores said plurality of virtual book objects, said configured virtual characteristics, and said plurality of link objects;
wherein said plurality of virtual book objects are maintained in said predetermined format, at configurable locations on said plurality of virtual shelves, and wherein selecting a particular virtual book object from said plurality of virtual book objects opens at least one of an associated electronic file, an associated electronic directory, an associated electronic folder, an associated website, and an associated URL, corresponding to said link object.

2. The graphical display system of claim 1 wherein said size characteristic includes a height, a width, and a thickness of each said virtual book object and wherein said publisher module allows configuration of said height, said width, and said thickness of said virtual book.

3. The graphical display system of claim 1 wherein said virtual characteristics include a title font and a title font color of each said virtual book object and wherein said publisher module allows configuration of said title font and said title font color.

4. The graphical display system of claim 1 wherein said library module receives navigation input and provides a plurality of views of said plurality of virtual shelves for displaying said virtual book objects corresponding to said navigation input.

5. The graphical display system of claim 1 further comprising a search module for that receives search text input and that displays at least one virtual book object from said plurality of virtual book objects based on said search text input.

6. The graphical display system of claim 5 wherein said search module displays a location of said at least one virtual book object within said plurality of virtual shelves.

7. The graphical display system of claim 1 further comprising a native interface module for receiving a selected link object from a native operating system in communication with said graphical display system.

8. The graphical display system of claim 1 wherein said predetermined format includes a plurality of virtual book cases, each virtual book case comprising a plurality of virtual shelves.

9. A method comprising:
receiving a plurality of link objects, each link object being associated with at least one of an electronic file, an electronic directory, an electronic folder, a website, and a uniform resource locator (URL);
generating a plurality of virtual book objects, each virtual book object corresponding to a link object of said plurality of link objects;
configuring virtual characteristics associated with each virtual book object of said plurality of virtual book objects, said virtual characteristics including at least one of a size characteristic, a color characteristic, and a texture characteristic;
displaying said plurality of virtual book objects within a predetermined format including a plurality of virtual shelves for displaying said virtual book objects, at configurable locations within said plurality of virtual shelves;
selecting a particular virtual book object from said plurality of virtual book objects located within said plurality of virtual shelves, said particular virtual book object having a particular associated link object;
opening at least one of an associated electronic file, an associated electronic directory, an associated electronic folder, an associated website, and an associated URL, corresponding to said particular associated link object according to said selecting.

10. The method of claim 9 wherein said configuring said virtual characteristics including said size characteristic includes configuring a height, a width, and a thickness of each said virtual book object.

11. The method of claim 9 wherein said configuring said virtual characteristics includes configuring a title font and a title font color of said virtual book object.

12. The method of claim 9 further comprising:
receiving navigation input;
displaying a plurality of views of said plurality of virtual shelves for displaying said virtual book objects corresponding to said navigation input;

13. The method of claim 9 further comprising:
receiving search text input;
displaying at least one virtual book object from said plurality of virtual book objects based on said search text input.

14. The method of claim 13 further comprising displaying a location of said at least one virtual book objects within said plurality of virtual shelves.

15. The method of claim 9 wherein said receiving said plurality of link objects includes receiving a selected link object from a native operating system.

16. The method of claim 9 wherein said displaying includes displaying said plurality of virtual book objects includes displaying said plurality of virtual book objects amongst a plurality of virtual book cases, each virtual book case comprising a plurality of virtual book shelves.
